(19) United States
(12) Patent Application Publication
(10) Pub. No.: US 2023/0204792 A1
(43) Pub. Date: Jun. 29, 2023

(54) ASSISTED SATELLITE TIME AND LOCATION

(71) Applicant: Satelles, Inc., Reston, VA (US)

(72) Inventors: DAVID G. LAWRENCE, Santa Clara, CA (US); H. STEWART COBB, Reston, VA (US); GREGORY GUTT, Herndon, VA (US); MICHAEL L. O'CONNOR, Redwood City, CA (US); FRANCOIS TREMBLAY, Reston, VA (US)

(21) Appl. No.: 17/560,669

(22) Filed: Dec. 23, 2021

(51) Int. Cl. G01S 19/25

(52) U.S. Cl. CPC G01S 19/25

(57) ABSTRACT

For assisted satellite time and location (STL) in low earth orbit (LEO) and/or burst transmission-based STL, assistance is provided. Ephemeris information is provided to receivers of signals from LEO satellites, allowing the receivers to operate better in PNT based on the signals from the LEO satellites. Other information may be used to assist, such as terrestrial-based time and/or location of the receiver. For burst transmissions, the data (e.g., spread code) used for some or all the burst transmission is provided to the receiver, which may then replicate the signal. This replica signal assists in PNT based on the signals from the satellites transmitting the burst signals.

### BACKGROUND

The present embodiments relate to satellite-based positioning and/or timing. Global Navigation Satellite Systems (GNSS), like Global Positioning System (GPS), provide position, navigation, and timing (PNT). GPS has medium earth orbit satellites that transmit a continuous signal with a known or derivable code. For low signal-to-noise environments, the known code may be used to assist in PNT. This may result in a more rapid fix. Ephemeris and other information may be provided to the GPS receiver to assist in PNT.

Auxiliary systems may provide PNT. Industry examples of auxiliary systems include Satelles, NextNav, and IEEE-1588 systems. These type of auxiliary PNT systems may use low earth orbit (LEO) satellites and/or burst transmissions, for which assistance is not provided.

### SUMMARY

By way of introduction, the preferred embodiments described below include methods, computer readable storage media, receivers, and systems for assisted satellite-based time and/or location (STL) (ASTL. For LEO and/or burst transmission-based STL, assistance is provided. Ephemeris information is provided to receivers of signals from LEO satellites, allowing the receivers to operate better in PNT based on the signals from the LEO satellites. Other information may be used to assist, such as terrestrial-based time and/or location of the receiver. For burst transmissions, the data (e.g., spread code) used for some or all the burst transmission is provided to the receiver, which may then replicate the signal. This replica signal (signal replica) assists in PNT based on the signals from the satellites transmitting the burst signals.

In a first aspect, a method is provided for assisting satellite time and/or location determination. A receiver receives a signal broadcast from a satellite. The signal has a high peak power flux density and includes at least one characteristic unpredictable from the signal by the receiver. The at least one unpredictable characteristic of the signal is approximated based on aiding information. Time and/or location of the receiver are determined from the signal and the approximation of at least one characteristic of the signal.

In a second aspect, a system is provided for assisting satellite time and/or location. A receiver is configured to receive a signal from a satellite. The signal has a high peak power flux density and includes at least one characteristic unpredictable by the receiver. A processor is configured to approximate the at least one unpredictable characteristic of the signal based on aiding information and to determine time and/or location of the receiver from the signal and the approximation of at least one unpredictable characteristic of the signal.

In a third aspect, a method is provided for assisting satellite time and/or location determination. A receiver receives a signal broadcast from a low earth orbit satellite. The signal has a high peak power flux density and includes a characteristic unpredictable from the signal by the receiver. The unpredictable characteristic of the signal is approximated with aiding information. The time and/or location of the receiver are determined from the signal with the approximation of the unpredictable characteristic.

In a fourth aspect, a system is provided for assisting satellite time and/or location. A receiver is configured to receive a signal from a low earth orbit satellite. The signal includes a characteristic unpredictable from the signal by the receiver. A processor is configured to approximate the at least one unpredictable characteristic of the signal based on aiding information and to determine time and/or location of the receiver from the signal and the approximation of at least one unpredictable characteristic of the signal.

In a fifth aspect, a method is provided for assisting satellite time and/or location. Assistance data is received from a server, a first receiver, or a prior received satellite signal. A satellite signal is received from a satellite at a second receiver. (1) The satellite is a low earth orbit satellite, (2) the satellite signal is a burst transmission, and/or (3) the satellite signal is in a beam smaller than a total transmission footprint of the satellite. The time and/or location of the second receiver is determined from the satellite signal and the assistance data, the assistance data setting bounds of a search to match the satellite signal.

The present invention is defined by the following claims, and nothing in this section should be taken as a limitation on those claims. Any one or more features discussed herein may be used alone or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1A illustrates one embodiment of a satellite system for assisting STL for LEO and/or burst transmissions, and FIG. 1B illustrates another embodiment of the satellite system;

FIG. 2A illustrates an embodiment of data provided from a server to assist a receiver in STL for LEO and/or burst transmissions, and FIG. 2B illustrates a replica signal;

FIG. 3A is an example plot showing time error over time for clock bias and/or frequency error determination, and FIG. 3B is an example plot showing a sum of absolute value of correlation over clock error;

FIG. 4 is a flow chart diagram of one embodiment of a method for assisting STL for LEO and/or burst transmissions;

FIG. 5 illustrates another embodiment of the satellite system;

FIG. 6 illustrates an embodiment of receiver processing to determine time and/or location using assistance data; and

FIG. 7A shows example correlation magnitude plot, and FIG. 7B shows part of the plot of FIG. 7A.

### DETAILED DESCRIPTION OF THE DRAWINGS AND THE PRESENTLY PREFERRED EMBODIMENTS

External data or internal feedback from within a receiver combined with knowledge about broadcast patterns (e.g., if a burst is received at time X, another burst one with comparable doppler is likely to be received at time X+Y seconds where Y is the typical repeat period) assists in STL tracking, geolocation, or validation. External data may include broadcast details, such as the exact times of bursts and the exact data associated with those bursts. That information, coupled with a coarse estimate of time and location, may allow bursts to be detected at lower signal-to-noise ratios (SNRs) (e.g., inside a building, parking garage, or within a city) and/or with less signal processing resources and/or power consumed.

LEO satellites may be used for PNT. Assistance may be provided for determining time and/or location for such systems, which may transmit burst signals in beams. For example, ephemeris data is provided to the receiver from an external source, allowing the receiver to more rapidly and/or more reliably determine time or location. As another example, LEO satellites or satellites in other orbits may use burst transmissions for PNT. The coding for any given burst may not be known or predictable. By providing the spreading code for the burst, a replica signal may be generated and used in correlation, allowing more reliable and/or rapid determination of location and/or time. Spot beams (more received power per broadcast watt), LEO (i.e., closer, so more received power per broadcast watt), and burst transmission (e.g., TDMA) (more received energy without long averaging times that is susceptible to carrier multipath) combine to make assisted STL indoor sensitivity per broadcast watt much better than designs that don't have those features.

Assisting for STL using burst and/or beam transmissions may allow for timing and/or location in indoor or other high attenuation environments. A continuous fixed power broadcast like GPS, even when 20 msec integration barrier is eliminated by wiping off the data, can suffer from carrier multipath over longer integration intervals. As a GPS satellite moves across the sky, the signal received by an indoor user may have different carrier delays as different paths become more or less dominant (e.g., the signal is received through paths going through two windows with reflections off neighboring buildings). The effective carrier phase depends on both the path length due to reflections and the attenuation of each path. Burst transmissions have energy condensed into short time intervals so integration periods may be shorter and less susceptible to multi-path changes that prevent constructive integration of the signal over longer intervals. Assistance for low SNR may allow burst transmission-based STL to provide more reliable indoor timing and/or location.

Other data may provide hints to assist in time and/or location determination. The data may include possible bursts for a specific satellite vehicle, possible bursts for a specific synchronization pattern or possible bursts for multiple synchronization patterns. A subset of sync patterns may be searched for based on approximate location and data from the internet (or internal feedback from historical tracking) about what satellites are in view. A burst on frames may be searched for when a burst is known to have been broadcast. The data include possible bursts for signal processing detection and/or refinement. The frame time and/or synch pattern may be provided, assisting in detection. The data for the burst (e.g., spread code) may be provided to assist in detection or refinement. The hints may assist in acquiring bursts with better sensitivity and/or lower power consumption, lowering signal processing resource requirements. The signal processor uses any combination of this hint information to achieve determination of time or location.

Navigation based on a burst signal structure and/or from LEO satellites benefits from assistance. By assisting in STL, tracking sensitivity, time to fix, power consumption, processing resources required for tracking low SNR bursts, and data decoding issues may be limited or avoided.

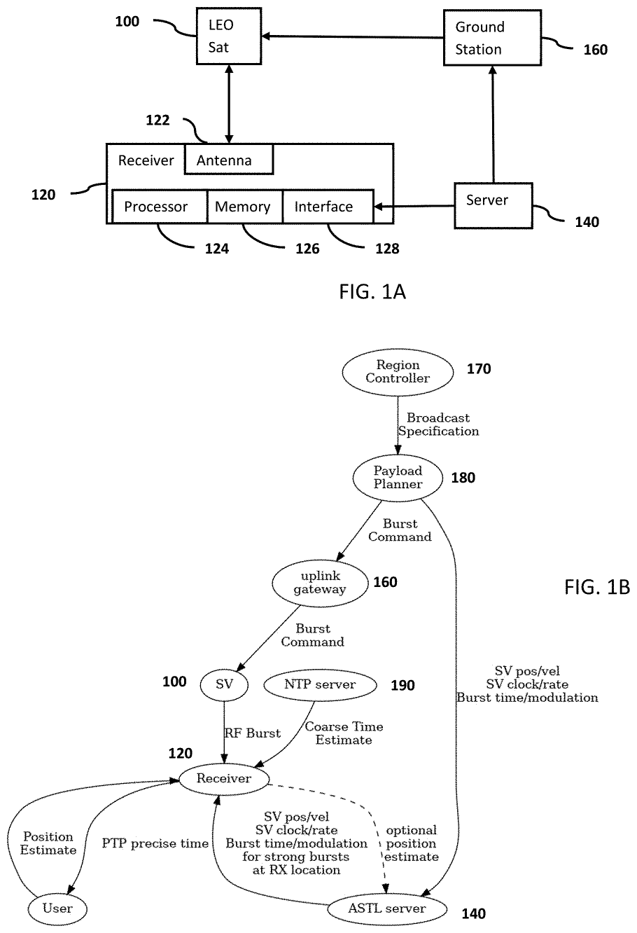

FIG. 1 shows one embodiment of a satellite system. This satellite system is a LEO and/or burst-based system for STL. The receiver 120 is assisted to better handle the determination of location and/or time from signals of the satellites 100.

The satellite system includes a space segment (e.g., satellite 100) and a ground segment (e.g., user receiver 120, server 140, and satellite ground station 160). Additional, different, or fewer components may be provided. For example, multiple satellites 100 and/or receivers 120 are provided. As another example, the ground segment does not include the server 140 and/or ground station 160. In yet another example, only the receiver 120 is provided.

One or more satellites 100 are provided. A constellation of tens, hundreds, or thousands of satellites 100 may be provided. The satellites 100 are configured to transmit PNT signals. The satellites 100 are in any orbit. In one embodiment, the satellites are in LEO. For example, the satellites 10 are Iridium satellites. The satellites 100 may be satellites of the Kuiper, OneWeb, SpaceX, and/or Small/Cube/Micro/SpaceBEEs systems. One, more, or all the satellites 100 may be in middle earth orbit or another orbit (geosynchronous).

The satellites 100 are wireless signal transmitters. The satellites 100 include a reference oscillator, voltage-controlled oscillators, a clock generator (crystal oscillator or another clock), a high-rate digital code generator, mixers, filters, a timer and switch, an antenna, a microprocessor and/or a summer. Additional, different, or fewer components may be provided. The satellites 10 are configured by software, firmware, and/or hardware to transmit the signals to the receivers 120.

The satellites 100 broadcast or directionally transmit PNT signals. In one embodiment, the satellites 100 have hardware, firmware, and/or software for transmitting in multiple beams, either sequentially or simultaneously. Each beam intersects the earth in a geographical region separate from the other beams of the same satellite 100. The beam is a portion or subset of the transmission footprint of the satellite on the earth. Each satellite 100 may have any number of beams, such as two, three, or more. In other embodiments, the satellite 100 has a single beam or broadcasts to the entire footprint without subdivision into beams. In yet other embodiments, the satellite 100 has a single beam that only convers a fraction of the satellite footprint.

The signals may have various structures. For example, the signals are burst transmissions, such as time division multiple access signals. The ground station 160 provides the modulation (e.g., spread code or forward error correction) or a key for the modulation. The signals include signal modulated over the burst with other information. Spread code for the modulation is used in examples herein. The signals may include ephemeris or validation information. Each burst uses a different spread code, cycling through spread codes over a series of bursts. As another example, shift keying is used with or without bursts (e.g., continuous signals).

The ground station 160 is an uplink facility or antenna and electronics for sending data to the satellites 100. The ground station 160 is configured to transmit the code to use in transmissions or a key for the satellite 100 to use to generate the code. Other data for generating the signals may be transmitted from the ground station 160 to the satellite 100.

In one embodiment, the ground station 160 is operated by the same entity as the satellites 100. The server 140, operated by a different entity, provides the codes or keys for transmission by the satellites 100 to the ground station 160.

The server 140 is a computer or another processor for providing information. The server 140 provides codes or a key defining codes to the ground station 160 for creating the signals transmitted by the satellites 100. The server 100 provides burst requests or other signal definition to the ground station 160.

The same or different server 140 provides assistance to the receivers 120. Assistance information (aiding information) is transmitted to the receiver 120.

One receiver 120 is shown for simplicity. There may be one, two, or more receivers 120, such as tens, hundreds, or thousands of receivers 120. The receiver 120 is user equipment that uses signals from the satellites 100 to determine timing and/or location, such as being navigation devices or a computer network timing source.

The receiver 120 may include an antenna 122, interface 128, memory 126 and/or processor 124. Additional, different, or fewer components may be provided. For example, the receiver 120 includes an oscillator, phased-lock-loop circuit, field programmable gate array, application specific integrated circuit, multi-thread processor, signal processor, general processor, graphics processing unit, correlation processor, digital circuit, analog circuit, combinations thereof, or another device for satellite time and location.

The antenna 122 is a single antenna or array of antennas. The antenna 122 is shaped and/or sized to receive the signals from the satellites 100. The antenna 122 is configured to receive burst signals from multiple satellites 100, such as receiving time division multiple access signals. Alternatively, the antenna 122 and/or receiver circuit is configured to receive continuous signals from the satellites 100. The antenna 122 may receive shift keyed signals or other modulated signals. The antenna 122 is configured to receive signals broadcast from the satellites 100.

The receiver 120 receives the signals. The signals include coding, such as a spread code, forward error correction or other coding (modulation). The coding is unpredictable to the receiver 120 based on the signals using the coding from the satellites. The code varies burst-to-burst, so at least some coding may not be predictable based on previous signals. The signals from the satellites 100 cannot be used to predict the next code to be used.

The interface 128 is configured by hardware, firmware, and/or software to receive information. The interface 128 may be a wired or wireless interface. For example, a cellular, Wi-Fi, or ethernet interface is provided. In one embodiment, the interface 128 is a communications interface, such as computer network interface, high speed serial port interface, or wired or wireless connection for receiving from a network or other device. In alternative embodiments, the interface 128 is not provided. Instead, the assistance is internal to the receiver 120, such as being pre-loaded in memory and/or determined by data processing previous signals.

The interface 128 is a network interface for receiving data from the server 140 or another source. The interface 128 uses terrestrial communication (i.e., radio, cellular, or wired—not from a satellite). In other embodiments, satellite communications are used, but from a different satellite 100.

The interface 128 is configured to receive information used to assist in determining location and/or time from the signals from the satellite 100. For example, time information is provided, such as using NTP or other timing protocol of a computer network. The time information may be used to set a period or width of a time window for receiving a burst. Having the assistance allows for a narrower window. As another example, position of the receiver 120 is provided, such as based on an address, installation input, and/or cellular positioning. The position may be used to identify the position more rapidly from the signals from the satellite, such as providing a starting point for identifying peak correlation. In yet another example, ephemeris (e.g., velocity and location) of the satellite 100 is provided. Ephemeris may be any information that can be used to find the position and velocity of the satellite (e.g., (1) position and velocity or (2) orbit parameters). Like receiver position, the ephemeris may be used to set the range of distances more narrowly from the satellite 100 to the receiver 120, allowing more rapid position or time determination. Ephemeris and receiver position together may further speed the determination of time and/or location. Frame time, synch pattern, and/or other information about the signal modulation may be provided to assist.

In one embodiment, the interface 128 receives signal information. For example, a key or code provided to the ground station 160 is also provided to the receiver 120. The code or symbols used in the transmission from the satellite 100 are provided to the receiver 120. Less than that entire signal request (e.g., burst request) may be provided. For example, the data for forming the signal from the satellite includes security or validation information. This validation or security information is not provided to the receiver 120. The other data, such as the modulation (e.g., spread code) as the actual code or a key to generate the modulation (e.g., spread code), is provided. In one example, the signal information provided by the server 140 to the interface 128 includes data of the signal (e.g., data bits of the burst signal or modulation), position of the satellite, a velocity of the satellite, and clock information (e.g., clock and/or frequency bias) for the satellite. The broadcast server 140 sends information about a subset of each burst request or a subset of burst requests before or after the satellite signals are broadcast (each subset excludes any validation bursts and/or does not include bits related to validation that could be used to reduce the security of validation). The position, velocity, satellite clock, and data bits (with the aforementioned exception) would be included. Ephemeris data is provided from the broadcast server 140 or another server with knowledge of precise satellite ephemeris. The ephemeris for the satellite 100 is provided from a source other than the satellite 100.

In another embodiment, a static timing receiver 120 in a high attenuation environment is provided its location (e.g., the installer finds coordinates from a map based on the known location in the building and estimates altitude from ground elevation and floor number). The receiver 120 also receives a coarse time (e.g., sub-second timing) from a network time protocol (NTP) or other source.

The assistance data is received from the server 140, another receiver, and/or a prior received satellite signal. For example, the assistance is from a prior received burst signal that may be used to constrain the search space, allowing a smaller frequency search (e.g., a burst signal from a satellite with line-of sight to the receiver through a door or window is received and used to estimate some aspect of the modulation or timing used by the satellite for constraining the search for a later signal from the satellite in a more attenuating situation (no direct line through a door or window). Other sources may be provided.

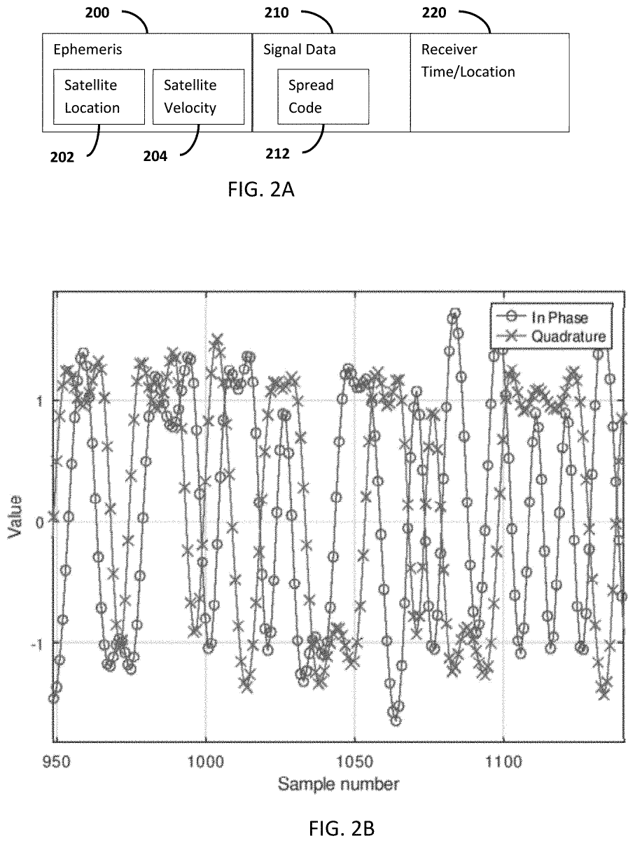

FIG. 2 shows one example of a collection of assistant data. The assistance data includes the ephemeris 200 (e.g., satellite location 202 and satellite velocity 204), signal data 210 (e.g., modulation such as spread code 212), and/or receiver time and/or location 220.

The memory 126 is a volatile or non-volatile memory. For example, the memory 126 is a cache, solid-state, random access memory, or other memory. The memory 126 is configured by hardware, firmware, and/or software to store the assistance information, such as ephemeris, receiver location, computer network time, and/or signal information for the signal to be transmitted by the satellite 100. The assistance provided by the server 100 or another source via the interface 128 is stored. Instructions for execution by the processor 124 and/or interface 128 may be stored in the non-transitory memory.

The signal information may be provided prior to receiving the signal from the satellite 100. Thus, the signal information is stored. In other embodiments, the signal information is provided after receiving the signal from the satellite generated using the signal information. Thus, the signal from the satellite is stored. The memory 126 may store data during processing, such as storing a replica signal, matched filter, and/or other information.

The processor 124 is a server, a computer, or another processor for determining time and/or location with assistance. For example, the processor 124 is a backend processor or signal processor, such as a field programmable gate array, application specific integrated circuit, multi-thread processor, signal processor, general processor, graphics processing unit, correlation processor, digital circuit, analog circuit, combinations thereof, or another device. In other embodiments, the processor 124 is a computer network or distributed arrangement of processors. For example, the processor 124 includes a field programmable gate array or application specific integrated circuit for correlation and another general processor or digital signal processor for determining location and/or time from correlation information.

The processor 124 is configured by software, firmware, and/or hardware to determine time and/or location based on the signal from the satellite 100. Signals from three, four, or more satellites 100 are used to determine position by triangulation. Fewer or more satellites 100 may be used, such as where the number of unknowns is less. A static receiver may find the location with a single satellite, such as where altitude is constrained, and the satellite does not pass near overhead of the receiver or where an inertial measurement unit is provided in the receiver in some conditions.

The processor 124 is configured to determine the time and/or position in a way assisted by the assistance data (e.g., signal information) in memory 126 or from the interface 128. For example, the determination is assisted by the ephemeris, receiver position, and/or receiver time. For a LEO satellite 100, the ephemeris of the satellite 100 may be used to initially set the time and/or position window for searching for time or position from the signals from the satellite. The window may be narrower or smaller due to initially having the satellite 100 and/or receiver 120 information, allowing more rapid determination with less processing. An estimate of frame time and/or synch pattern may assist.

An estimate of receiver time or location, or other assistance data, may be used to constrain the search. In one embodiment, the assistance constrains the searching for a match. For example, the modulation is keyed to a limited number of combinations. The assistance data may indicate parts of the keying, such as M synchronization codes being useable in combinations to form many different burst signals. The processor creates replica signals for the different combinations and searches by matching with the received burst signal. The assistance data may indicate a sub-set of the keys to use, limiting the number of combinations and corresponding replica signals.

In one embodiment, the processor 124 is configured to determine the time and/or position based on signal information as the assistance. A replica signal is reconstructed to assist. The signal information, such as the modulation or data bits of the expected signal from the satellite, is used to generate a replica of the expected signal. For example, a same spread code used in a burst transmission or signal is used to reconstruct the replica prior to receipt of the burst from the satellite 100. FIG. 2B shows part of a replica signal in an in-phase and quadrature representation. The replica signal has any number of samples and any dynamic range of sample values.

Generation of the replica signal may be performed for each burst or over a series of bursts. For each burst, an expected burst waveform is predicted based on receiver location, satellite position and velocity, and the modulated data from the broadcast server 100.

The replica signal may be less than entirety of the signal received from the satellite 100. For example, the replica signal has signal for at least 60, 70, 80, 90, or 95% of the signal. The burst signal from the satellite 100 contains a given number of bits or symbols. The replica signal has any number of bits or symbols, where at least the percentage (e.g., 50, 60, 75, 80, 90, 95, or 99%) of the bits or symbols of the burst signal from the satellite 100 are generated. This replica signal is generated based on a location of the low earth orbit satellite 100 from the ephemeris as the assistance and the signal information as assistance to determine the time and/or location based on correlation of the replica signal with the signal from the low earth orbit satellite. By knowing at least part of the coding for the signal, the correlation may be more accurate, allowing correlation in lower signal-to-noise ratio environments.

In one embodiment, the processor 124 is configured to build a matched filter based on the replica signal. For example, the replica signal is generated and then a plurality of versions of the replica signal are formed with different frequency offsets. One or more replica bursts are created from the expected burst waveform with different frequency offsets to reflect receiver clock frequency errors. To determine time and/or location, each replica burst for the expected burst waveform is correlated with samples in the receiver time of arrival window. Alternatively, a replica burst is correlated against multiple sets of sample data (e.g., signal received from the satellite 100) mixed with different frequencies. Matched filtering is not provided in other embodiments. Other arrangements applying different frequency offsets to the replica signal and/or burst signal for correlation to search for a match may be used.

The time and/or location is determined from the burst signal or other signal from the satellite 100 using the matched filter or replica signal for assistance. For example, the range or pseudorange to the satellite 100 from the receiver 120 is determined by correlation of the burst signal with the matched filter or replica signal and the ephemeris. The ranges or pseudoranges from multiple satellites 100 are similarly determined, allowing determination of position.

As another example, the time is determined based on a receiver clock bias determined by correlation of the burst signal with the matched filter. The time may be alternatively or additionally determined based on a frequency error determined by correlation of the burst signal with the matched filter. Samples from many bursts may be used to determine the time using the replica signals. Fewer samples may be needed due to having the replica signals.

In one embodiment, burst signals and replicas are correlated. Correlation peaks with wild point filtering are used in conjunction with ephemeris data provided from the server 100 to update an estimate of the receiver clock bias (i.e., the location of the peak relative to expected for a perfect clock) and/or frequency error. Using the matched filter, the best matching frequency is deduced from which downconverted samples yielded the biggest correlation peak. Wild point filtering allows aggressive correlation peak thresholds to be used, which intentionally lets spurious peaks through to improve sensitivity. The highest peak for each correlation could be used with no regard to peak size, or the peak size could be used as an input to a wildpoint filter that considers all bursts.

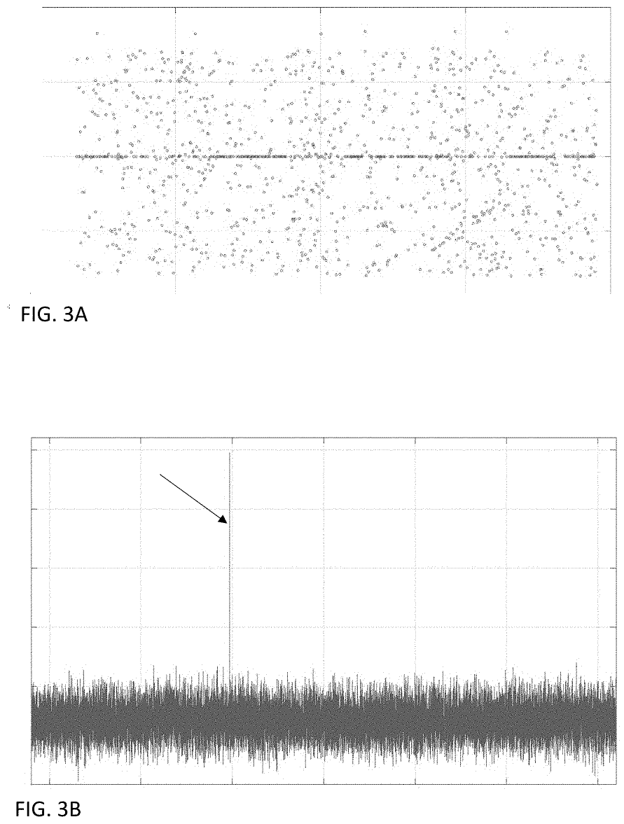

FIG. 3A shows an example plot of a per burst estimate of receiver clock error vs time derived from the location of the peak correlation described above. The plot shows a line for which bursts correlations found the true burst from the peak correlation. The wild point filter would remove the outlier clock error estimates and average the remaining estimates to get a smoothed estimate of clock error assuming no frequency error. In this plot of FIG. 3A, a very stable clock frequency source was used, so there is no slope in the clock error vs time plot. For a receiver with a bigger clock frequency error, there would be a slope to the clock error estimate vs time plot. The slope and y intercept of the clock error vs time are estimated instead of just the y intercept in that case. The y value provides the clock error, and the slope provides the frequency error.

Any number of samples from any number of satellites and corresponding replicas may be used. Tens, hundreds, or thousands of sample correlation peaks may be found and used. Other approaches for determining time may be used, such as determining the time from a single signal and replica for each of one or more satellites 100. Additional doppler or frequency error refinement (e.g., interpolate between the different discrete frequency offsets in the replica bursts) and correlation may be used to improve time of arrival and receiver clock frequency estimates. In one embodiment, the receiver 120 has a sufficiently stable oscillator frequency such that only one replica burst per expected received burst is required (i.e., no frequency search to accommodate receiver frequency uncertainty).

In another embodiment, the receiver clock is assumed stable enough that the clock frequency error is constant (i.e., the error vs time in the time error vs time plot of FIG. 3A is a horizontal line). Instead of plotting the peak correlation value, the correlation curves are accumulated over time. A composite correlation curve is plotted or determined. After enough accumulations, the correct clock error eventually stands out from the noise. For example, FIG. 3B shows a sum of the absolute value of 1000 correlations from receiver data with 60 dB of simulated noise added to the signal. The receiver clock error can be found from the location of the peak (see arrow) in this accumulated correlation (around −0.0514844 seconds in this example).

The ephemeris may be used to assist in the processor 124 determination of the time and/or location. The ephemeris is used to assist by setting a range of a time window based on the ephemeris. For example, the ephemeris in combination with computer network time (e.g., NTP) and/or receiver location allow estimation of the time of arrival and/or uncertainty in receiver time, allowing narrowing of the correlation window and/or number of replica bursts in the matched filter. The time of arrival of the burst and uncertainty in receiver time are estimated based on receiver location, satellite position, and the time estimate of the receiver 120, which time estimate is coarsely initialized and subsequently refined to reduce uncertainty. Uncertainties in receiver clock bias and receiver clock frequency are reduced to decrease the correlation window and/or the number of frequencies (e.g., number of replica waveforms or number of downconversion buffers for different waveforms generated from the replica) searched for subsequent bursts.

In another embodiment, the memory 126 stores both the signal information and a number of possible symbols that be used for the burst signal. For example, the burst signal is generated using a key of six or eight options. Different combinations from the key group are used to generate different burst signals. The processor 124 is configured to reconstruct the replica signal as part of a search using the possible symbols. Rather than generate replica signals for all the possible combinations, the processor is configured to limit or constrain the search. The signal information is information (e.g., identifying a subset of the keys used in the combination) to limit the possible symbols to less than the number such that the search is reduced.

The processor 124 of the receiver 120 outputs the location and/or time. The time and/or location may be used for other processes, such as navigation or a source for time in a computer network. The precise time is provided from the receiver 120 using PTP or other clock synchronization protocol.

FIG. 1B shows another embodiment of the satellite system for assisted STL. The region controller 170, payload planner 180, and/or assisted STL (ASTL) server 140 are operated by one entity. The controller 170, planner 180, and server 140 are different computers, but may be a same computer in other embodiments. The region controller 170 provides region-based control, such as for a country or state. The region controller 170 provides a broadcast specification for that region. The payload planner 180 uses the specification to generate a burst command or request. The burst command is provided to the uplink gateway 160, which passes the command or instructions based on the command to the satellite 100. The satellite 100 transmits the radio frequency burst based on the burst command.

The payload planner 180 generates the satellite position, velocity, and clock/rate information, burst time, and burst modulation (e.g., coding) for the burst command. This assistance information is passed to the ASTL sever 140. The ASTL server may optionally receive position information for the receiver 120. The ASTL server 140 communicates the assistance information to the receiver 120. In this example, the assistance information is the satellite position, velocity, and clock/rate information, burst time, and burst modulation for the receiver 120 location and/or region.

The receiver 120 receives the assistance information and the RF burst. The receiver 120 may also receive a coarse time estimate from the NTP server 190 or the ASTL server 140. The user may input the position estimate for the receiver 120, or the position estimate is provided by another source (e.g., cellular positioning). The receiver 120 uses the assistance information to determine time and/or location from the RF burst. The precise time is then provided to the user, such as by display, or provided to other equipment for use by the user, such as a local area network.

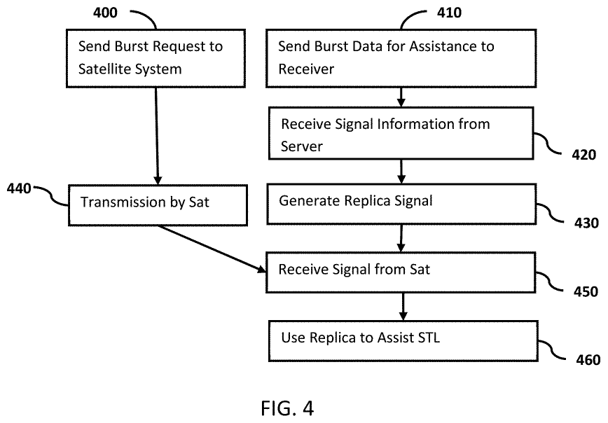

FIG. 4 is a flow chart diagram of one embodiment of a method for assisting satellite time and/or location. A receiver is assisted in determining time or location from signals from LEO satellites and/or in burst transmissions. External and/or internal information is used to assist in the determination.

The method includes different flows for different actors, such as acts 400 and 410 being performed by a server or processes controlled by one entity, act 440 being performed by a satellite controlled by another entity, and acts 420, 430, 450, and 460 being performed by a receiver. Other arrangements may be used.

The acts are performed in the order shown (e.g., top to bottom or numerical) or another order. For example, acts 400 and 410 are performed simultaneously, act 400 before act 410, or act 410 before act 400. As another example, acts 440 and 450 are performed prior to act 410, 420, and/or act 430.

Additional, different, or fewer acts may be provided. For example, acts 400 and 410 are performed without performing the other acts. In yet another example, acts 420, 430, 450, and 460 are performed without performing acts 400 and/or 410.

In act 400, a server, such as operated by one entity, sends burst requests for signals to be included in satellite burst transmissions. The data for generating the burst signals for the different transmitters and/or satellites in a constellation is provided to an operator of the satellites (e.g., to a ground station) and/or to the satellites. The code itself (e.g., spread code or shift keying code) or a key for generating the code (e.g., 7 bits defining the code) is sent. The data may include a spread code or other coding for generating the burst signals. Ephemeris, validation, security, keys, timing of transmission, and/or other data may be included. The data to generate the burst transmissions is provided. In alternative embodiments, the data to generate a continuous signal is provided.

In act 410, the same or different server sends data for assistance in location or time determination to the receiver. The same or different entity sends the assistance data. For example, the server performs both acts 400 and 410 with any relative timing (e.g., same time or act 410 before act 400). In one embodiment, the entity sourcing the signals to be broadcast by the satellites also sources the assistance data provided to the receivers.

Any type of assistance data for use in determining time or location from LEO satellites and/or burst transmissions may be sent. For example, ephemeris data for a satellite performing the satellite burst transmission is sent. As another example, receiver location data and/or time data is sent. In one embodiment, burst data is sent to the receiver prior to the satellite burst transmission of act 450. The receiver is configured to receive the satellite burst transmission from act 450 and determine the time and/or location from the satellite burst transmission based on assistance from the burst data provided in act 410.

In one embodiment, the assistance is data to allow creation of one or more replica signals. The coding and/or other data used to generate the burst signal by or for the satellite is sent to the receiver. The data may be a subset of the burst request, such as using the same data but without validation or security sensitive data. Most of the data is provided for generating the replica signal. The receiver generates one or more replica signals for each signal from the satellite (e.g., for each burst).

The data for assistance is broadcast, such as using broadcasting to multiple receivers in a computer network. The data may be sent directly to or addressed for specific receivers in other embodiments.

In act 420, the receiver receives assistance data. The interface of the receiver receives via wired or wireless computer network communication. Other terrestrial or non-terrestrial communications may be used. Alternatively, the receiver receives from on-board processing. For example, a previous time and/or location determination and knowledge about frequency of burst transmission allows identification of an expected time window for receiving a subsequent burst.

Any assistance data may be received. For example, ephemeris (e.g., satellite position and satellite velocity), data for the signal, and/or signal coding are received. The data for generating the signal is received.

The assistance data is received prior to receiving the satellite signal in act 450. Alternatively, the assistance data is received in act 420 after act 450. The burst data (signal information) is sent after the broadcast of signals by the satellite. The samples from the satellite signal are buffered in the receiver. After a delay, the burst data is received by the receiver from any source.

In act 430, the receiver generates a replica signal from the satellite position, satellite velocity, and signal coding. Less information may be used to generate the replica signal. In other embodiments, assistance data is used without generating a replica signal.

The replica signal may be less than the entire signal to be transmitted by the satellite. The replica signal may or may not include filler (e.g., zero padding) to replace missing data, such as validation or security sensitive data.

A single replica is generated for each signal. Alternatively, a plurality of replicas is generated for each signal, such as replicating using different frequency errors or offsets. A matched filter may be created for the replica or replicas for each signal.

In act 440, the satellite transmits signals. The signals are broadcast for receipt by any number of receivers. The signals are continuous and from LEO. Alternatively, the signals are burst signals from LEO or other orbits.

The transmitted signals are generated by the transmitter of the satellite based on the burst request sent in act 400. The ground station and/or satellite uses the data in the request to generate the signal. After passing commands and/or the signal to the satellite from the ground station, the satellite generates the burst transmissions with the established coding at specific times. The transmission of the signals by the satellites occurs after some or all the assistance data is received by the receiver.

In act 450, the receiver receives the satellite signal from the satellite. The received signal includes the signal coding. For example, one or more burst transmissions are received from each satellite. The signals may be received from satellites in LEO or other orbits.

The received signal has coding from original data, resulting in unique or specific signals. Different bursts and/or satellites provide different signals with different coding.

In act 460, the receiver uses the assistance data to assist in time and/or location determination. For example, the replica signal or replica signals are used to assist. The replica signal(s) are correlated with the received satellite signal. The correlation peak may be used to indicate a clock bias, clock frequency error, and/or location. By having the replica for correlation, the time and/or location may be determined in higher noise, higher interference, or lower signal environments. Other assistance data may be used to limit searching, such as time windows or range windows, limiting power and processing and increasing speed of determination. The assistance data may be used for on-going or periodic determination and/or for an initial determination.

Various embodiments have the receiver receive the assistance information and perform the determinations of location or time. For example, the receiver receives satellite position, satellite velocity, and signal modulation from a server. The receiver then reconstructs the replica using searching constrained or assisted by the assistance information. In other embodiments, some or all this processing is performed elsewhere. For example, the server generates the replica signal using assistance information and sends the replica signal to the receiver. As another example, the receiver sends samples of a burst signal to the server. Then, the server uses the samples and assistance information to determine the clock error and/or position. The clock error and/or position are then provided to the receiver.

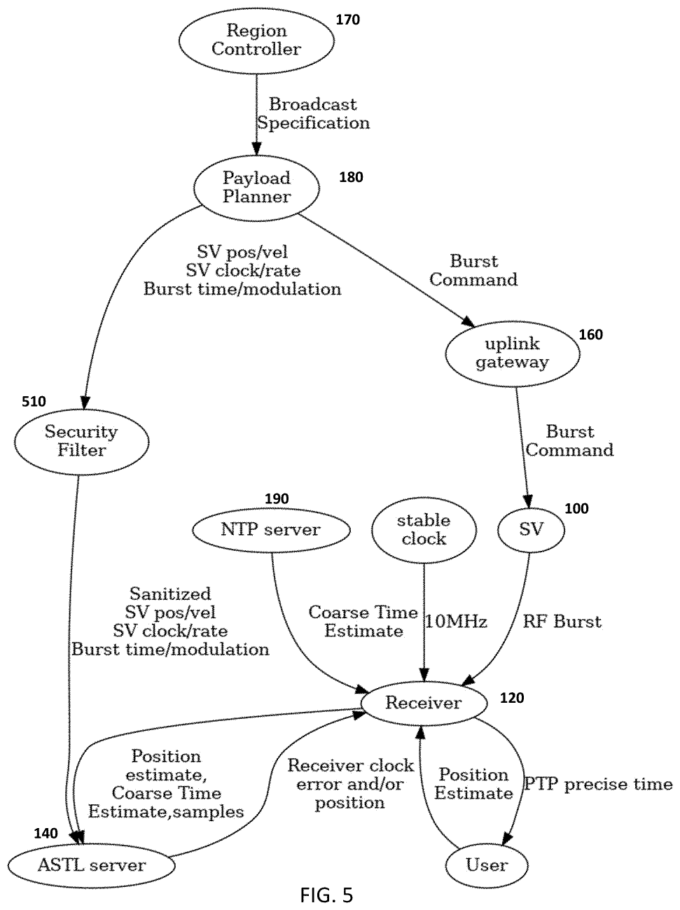

FIG. 5 shows an example where the assistance server 140 performs some of the processing, such as generating the signal replica and/or determining time or location. Any of the acts done by the receiver other than receiving the radio frequency signals from the satellite may be performed by the server.

Like in FIG. 1B, the region controller 170, payload planner 180, and/or assisted STL (ASTL) server 140 are operated by one entity. The controller 170, planner 180, and server 140 are different computers, but may be a same computer in other embodiments. The region controller 170 provides region-based control, such as for a country or state. The region controller 170 provides a broadcast specification for that region. The payload planner 180 uses the specification to generate a burst command or request. The burst command is provided to the uplink gateway 160, which passes the command or instructions based on the command to the satellite 100. The satellite 100 transmits the radio frequency burst based on the burst command.

The payload planner 180 generates the satellite position, velocity, and clock/rate information, burst time, and burst modulation (e.g., coding) for the burst command. This assistance information is passed to the ASTL sever 140 through an optional security filter 510. The ASTL server 140 receives any position and/or clock information for the receiver 120, such as receiving a position entered by a user as part of installation and a course time estimate from an NTP server 190, from the receiver 140. In one embodiment, the receiver 140 also provides samples from the RF signal received from the satellite 100. The ASTL server 140 uses the assistance information from the payload planner 180. In this example, the assistance information is the satellite position, velocity, and clock/rate information, burst time, and burst modulation for the receiver 120 location and/or region.

The assistance server 140 uses the assistance information to determine time and/or location from samples for the RF burst. The precise time (e.g., clock error or adjusted clock time) and/or position is then provided to the receiver 120, which may pass the time and/or position to the user, such as by display, or provided to other equipment for use by the user, such as a local area network. Instead of sending the aiding information from the ASTL server 140 to the receiver 120, the receiver 120 sends position estimate, coarse time, and samples (or doppler and range measurements for hot-start embodiments) to the server 140, and the server 140 tells the receiver 120 its clock error or time. The server 140 generates the replica signal and provides that replica to the receiver 120 for time and/or location determination in other embodiments.

In general, satellite-based time and/or location determination is assisted for non-GNSS satellite systems. A signal is broadcast from a satellite to provide a high peak power flux density on earth. Since with high peak power flux density may allow for position and/or timing determination in attenuation environments where GNSS signals cannot be reliably used. The time interval over which a signal can be coherently integrated can be limited by phase excursions resulting from indoor multipath instability and/or uncertainty in the receiver clock frequency. For example, without performing a frequency search, a 10 part per billion clock frequency error can accumulate a half cycle of error for a 1600 MHz signal in about 30 msec. Signals can be attenuated by more than 30 dB in indoor environments causing traditional satellite navigation systems to work poorly or not at all in many indoor environments. For example, a GPS signal with a power flux density of −132 dBW/m\hat{ }2 might be tracked with a C/NO of 48 dB-Hz outdoors, but in an indoor environment with 33 dB of attenuation, it would have a C/NO of only 15 dB-Hz. Due to uncertainties in receiver clock frequency and indoor multipath phase instability, one might only be able to coherently integrate the signal over a small fraction of a second. A 30 msec integration of a 15 dB-Hz signal will have a SNR of less than 0 dB making it difficult to distinguish the signal from the noise.

To enable the use of PNT satellite broadcasts in some deep indoor environments, a higher power flux density is desirable. Increasing the power flux density relative to traditional satellite navigation solutions can be achieved in several ways. Traditional commercial GNSS services are provided from MEO and/or GEO altitudes using a continuous signal in a single beam that covers nearly half of the earth. Decreasing the broadcast coverage footprint, either by using LEO satellites and/or using satellite transmit antennas that focus the power in an area significantly smaller than the satellite footprint, increases the power flux density for the same amount of broadcast power. Similarly, using a TDMA broadcast or otherwise broadcasting higher peak power than average power increases the peak power flux density relative to a continuous broadcast with the same average power. Some satellite power system constraints (e.g., solar panel capacity) put operational limits on average broadcast power; increasing the peak power flux density on earth for a given average power consumed can be achieved by a burst broadcast schedule. Using LEO satellites, beam transmissions with smaller footprint than the footprint of the satellite, and/or burst signals instead of continuous signals provides high power flux density.

GPS or other GNSS may have a power flux density in unattenuated environments near the surface of the earth of up to or around −128 dBW/m\hat{ }2. High power flux density may be greater, such as −125, −120, −115, −110, −105, or −102 dBW/m\hat{ }2. The power flux density may be high by being relatively higher than GNSS power flux density in a same position and/or environment (e.g., in a city or in a building) by 3, 8, 13, 18, 23, or 26 dBW/m\hat{ }2.

Assistance may provide for more rapid and/or accurate determination of time and/or location from the high flux density RF signals from the satellite 100. The RF signal may include one or more unpredictable characteristics. The characteristics of the signal are unpredictable to the receiver 140 and the receiver 140 may not be able to determine the characteristics from the signal having the characteristics. The unpredictable characteristics include satellite clock errors, location of the satellite 100 at the time of transmission or equivalent orbit data (e.g., ephemeris) and/or waveform details (e.g., the times of bursts, the satellites 100 from which those bursts will come, the receiver clock and orbital details at the time of the burst, and/or the QPSK or other symbols modulated onto the bursts). The characteristics may be predictable in some environments (e.g., open or low attenuation) but not predictable in other environments (e.g., high attenuation such as in a building). The receiver may not be able to determine the characteristics due to an inability in space and/or due to noise, interference, and/or attenuation. Knowing any of these unpredictable characteristics may assist in determining the location and/or time from the signal having those characteristics. For example, knowing at least some symbols of an N-PSK signal may assist in replicating the signal for correlation with the received signal. Determining the alignment of the signal in samples is assisted by having a more accurate replica to correlate with the samples of the received signal.

The receiver 120 receives the RF signal from the satellite 100. Aiding information is received by the receiver 120 or the server 140. The aiding information enables approximation of at least some of the unpredictable characteristics of the signal from the satellite 100. The signal received by the receiver is processed in conjunction with the aiding information to find the time and/or location of the receiver.

The processing is done in the receiver (see FIG. 1B). For example, the receiver 120 receives the same information from an assistance server as all other receivers in its region, and the receiver 120 handles all constraints specific to the receiver such as precise location. The receiver 120 uses the aiding information to determine time and location, such as by creating a signal replica. This type of system scales to support an arbitrary number of receivers 120 and requires only one way communication from the assistance server 140 to the receivers 120. Alternatively, the processing is done at a server 140 (see FIG. 5). For example, the server 140 gets samples, measurements, detailed location information, coarse time estimates, etc. from the receiver 120 and does custom processing for an individual receiver 120. This type of system requires communication from the receiver 120 to the assistance server 140 and requires per receiver processing power and memory at the assistance server 140.

The aiding information is provided to the server 140 and/or receiver 120 before the broadcast or after the broadcast of the signal corresponding to the aiding information by the satellite 100. The source of the aiding information is the server 140, such as the assistance server 140 with knowledge of the broadcast from broadcast provider (e.g., payload planner 180). In other embodiments, the source of aiding information is a second receiver in a better reception environment. In yet another embodiment, the source of aiding information is from the data received at the receiver 120 at an earlier time when the receiver 120 was in a better reception environment (e.g., timing of burst transmissions established when the receiver 120 was in the open and then use that timing to aid time or location determination based on signals received while the receiver 120 is indoors).

In other embodiments, this general approach is used in satellite systems not providing signals with high power flux density. For example, assisted navigation is provided using LEO satellites with traditional GNSS power flux densities.

Referring again to FIG. 5, the security filter 510 is implemented by a filter, computer, circuit, or other hardware. In other embodiments, the filter 510 is implemented as part of or by the computer or server of the payload planner 180, as part of the assistance server 140, or as a device between the assistance server 140 and receivers 120. The security filter 510 removes any sensitive future information, like future authentication data and future validation keys, from the assistance information (aiding information) before providing the assistance information to the assistance server 140.

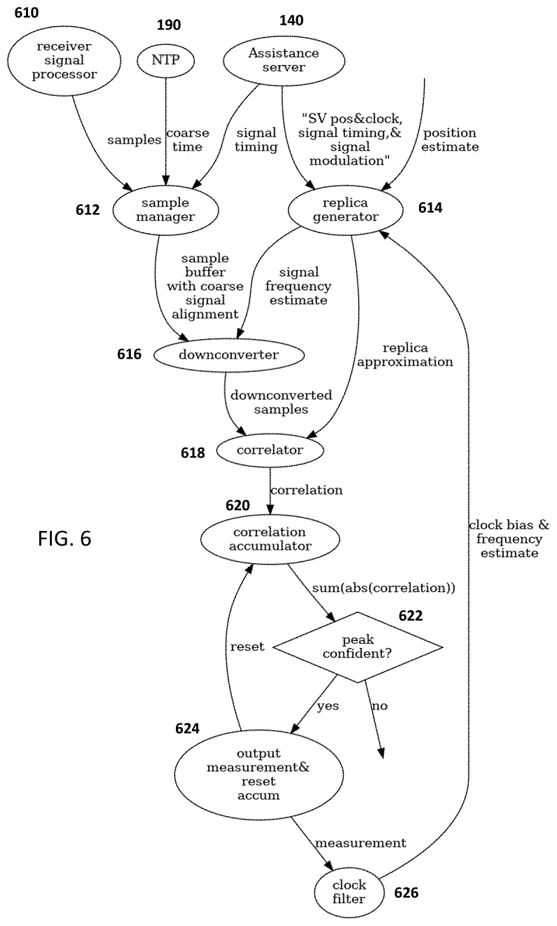

FIG. 6 shows an example embodiment of receiver-based processing of aiding information for determination of time from a LEO, burst, or beamed satellite transmission. The various components of FIG. 6 are implemented as separate hardware devices and/or as instructions implemented by a programmable processor.

The signal processor 610 of the receiver provides samples of the RF signal from the satellite to a sample manager 612. The course time is provided by an interface with a computer network to receive NTP time 190. The assistance server 140 provides signal timing information, such as expected timing of burst transmissions. The assistance server 140 also provides satellite position, velocity, or other orbit data, and/or clock information as well as signal timing and/or signal modulation to a replica generator 614. The replica generator 614 may receive a position estimate, such as input by the user.

The sample manager 612 outputs a sample buffer with a coarse signal alignment based on the assistance signal timing. The coarse alignment initializes and/or limits the correlation search, increasing speed of determination of the time and/or location. The downconverter 616 down converts the samples of the buffer. The down conversion may use an estimate of signal frequency from the replica generator 614. This signal frequency estimate is based on assistance information and assists in limiting a number of frequencies to use in the down conversion. The down converted samples are provided to the correlator 618. The correlator correlates the samples with the approximation of the signal (i.e., the signal replica) generated by the replica generator 614 based on the assistance data. The time and/or location may be more rapidly and/or reliably determined even in lower signal-to-noise environments where the correlation is with a replica mostly like the received signal.

The correlation accumulator 620 accumulates the sums of absolute values of the correlations. The accumulation may be a weighted accumulation with the weights being a function of the expected power of the received signal in an unobstructed environment, the expected power of the received signal in the actual environment based on models of that environment, or empirical observations in the actual environment or other factors. At 622, the peak of the accumulations is checked against a threshold. If the threshold is not met, accumulation continues. Once the threshold is sufficiently higher than other peaks, there is confidence that the peak corresponds to where the replicas are aligned with the true signal in the samples. At that time, a measurement comprising the peak location and possibly other metrics such as the peak value and accumulated correlation mean and standard deviation are output 624 to a clock filter 626. The accumulator 620 is also reset.

The clock filter 626 may be a Kalman Filter or other filter with states of clock bias and clock frequency error. Estimates of those states are fed back to the downconverter 616 to convert the signals down more accurately to a frequency of 0 and to the replica generator 614, which can adjust the timing of the replica to steer the expected peak to a fixed location such that the correlations can accumulate without smearing. In an optional embodiment, the coarse time estimates are replaced with time estimates from the clock filter 626 once the filter has a trusted output.

For lower attenuation environments, a single correlation peak will be enough to have confidence that the peak corresponds to the true signal alignment. In very high attenuation environments, it may take many correlations to gain that confidence. Resetting the accumulator 620 between measurement outputs will result in measurements that are each influenced by independent noise. If too many bursts are required before peak confidence is achieved, errors in the clock frequency could cause the peak to move such that the peak is smeared over many alignments and never stands out from the noise. In that case, the whole process can be run with multiple assumptions of receiver clock frequency error until a peak does appear. In very high attenuation environments, a large sample storage device (e.g., a hard drive or memory stick) and a very stable clock, such as an atomic frequency reference, can allow a peak to be detected in such a search.

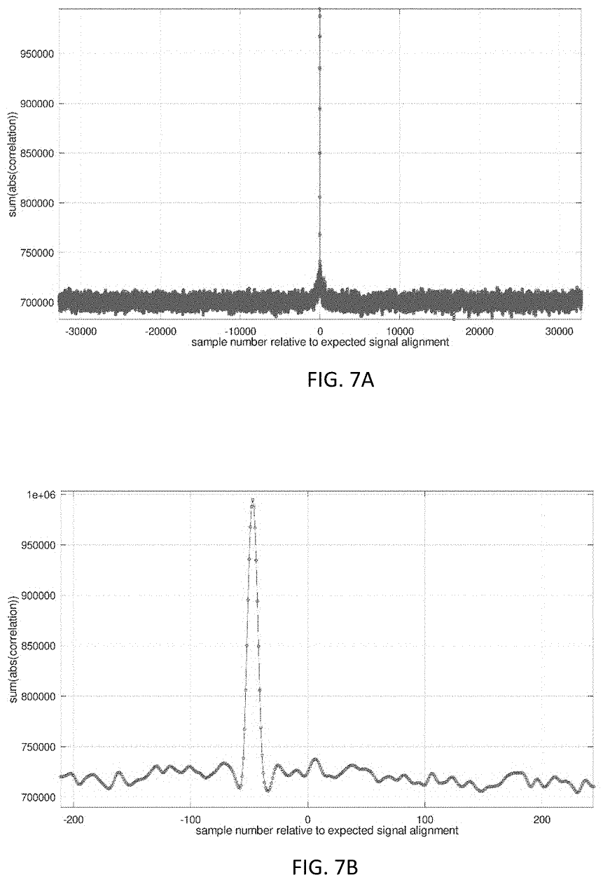

FIG. 7A shows an example of the correlation magnitude plot. FIG. 7B shows part of the same plot zoomed in at the peak correlation. The offset of the peak location from the expected location of the peak (defined to be 0 in these plots) is a measurement of clock bias estimation error that is the input to a clock estimation filter 626, such as a Kalman Filter. In the plot, the peak was around −47 samples, which would correspond to a clock bias error of about 0.235 msec for a sample rate of 200 kHz.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for assisting satellite time and/or location determination, the method comprising:
receiving, by a receiver, a signal broadcast from a satellite, the signal as broadcast having a high peak power flux density and including at least one characteristic unpredictable from the signal by the receiver;
approximating the at least one unpredictable characteristic of the signal based on aiding information; and
determining time and/or location of the receiver from the signal and the approximation of at least one unpredictable characteristic of the signal.

2. The method of claim 1 wherein the satellite comprises a low earth orbit satellite.

3. The method of claim 1 wherein the satellite transmits the signal in a beam having a beam footprint smaller than footprint of the satellite.

4. The method of claim 1 wherein the satellite broadcasts the signal with a peak power less than an average power.

5. The method of claim 1 wherein the satellite broadcasts the signal as a burst transmission.

6. The method of claim 1 wherein the unpredictable characteristic is ephemeris or satellite clock error.

7. The method of claim 1 wherein the unpredictable characteristic is a waveform characteristic.

8. The method of claim 1 wherein the unpredictable characteristic is at least some symbols of an N-PSK signal.

9. The method of claim 1 wherein approximating comprises creating a replica signal and wherein determining comprises finding an alignment of the signal in samples.

10. The method of claim 1 wherein the receiver approximates and determines.

11. The method of claim 1 wherein approximating comprises generating a replica signal from the aiding information comprising satellite position, satellite velocity, and signal modulation, the satellite position, satellite velocity, and signal modulation sourced from terrestrial communication, wherein the signal broadcast from the satellite has the signal modulation.

12. The method of claim 11 wherein the aiding information is received from a server by the receiver via the terrestrial communication.

13. The method of claim 11 wherein approximating comprises generating a replica signal and wherein determining comprises correlating the replica signal with the signal, a correlation peak indicating a clock bias.

14. The method of claim 11 wherein approximating comprises generating a replica signal and wherein determining comprises correlating the replica signal with the signal, a peak of a sum of correlation curves indicating a clock bias.

15. The method of claim 1 further comprising receiving the aiding information from a server, a first receiver, or a prior received satellite signal;
wherein receiving comprises receiving the signal from the satellite, wherein (1) the satellite is a low earth orbit satellite, (2) the signal is a burst transmission, and/or (3) the signal is in a beam smaller than a total transmission footprint of the satellite; and
wherein determining comprises determining the time and/or location of the receiver from the signal and the approximated at least one unpredictable characteristic, the assistance data assisting in a search to match the signal.

16. The method of claim 1 wherein a server approximates and determines and communicates the time and/or location to the receiver.

17. The method of claim 1 further comprising receiving the aiding information prior to the signal broadcast.

18. The method of claim 1 further comprising receiving the aiding information after the signal broadcast.

19. The method of claim 1 further comprising receiving the aiding information from a server with knowledge of the broadcast from a broadcast provider.

20. The method of claim 1 further comprising receiving the aiding information from another receiver.

21. The method of claim 1 further comprising receiving the aiding information as data received by the receiver while the receiver was in a better reception environment than a current reception environment.

22. A system for assisting satellite time and/or location, the system comprising:
a receiver configured to receive a signal from a satellite, the signal having a high peak power flux density and including at least one characteristic unpredictable from the signal by the receiver; and
a processor configured to approximate the at least one unpredictable characteristic of the signal based on aiding information and to determine time and/or location of the receiver from the signal and the approximation of at least one unpredictable characteristic of the signal.

23. The system of claim 22 wherein the receiver is configured to receive the signal wherein the satellite is a low earth orbit satellite

24. The system of claim 22 wherein the receiver is configured to receive the signal wherein the signal is a burst transmission.

25. The system of claim 22 wherein the receiver is configured to receive the signal wherein the signal is in a beam smaller than a total transmission footprint of the satellite.

26. The system of claim 22 wherein the receiver is configured to receive the signal wherein the signal has a peak power less than an average power.

27. The system of claim 22 wherein the unpredictable characteristics is ephemeris or SV clock error.

28. The system of claim 22 wherein the unpredictable characteristic is a waveform characteristic.

29. The system of claim 22 wherein the unpredictable characteristics is at least some symbols of an N-PSK signal.

30. The system of claim 22 wherein the processor is configured to approximate the unpredictable characteristic as a signal replica and configured to determine the time and location by alignment of the signal replica with the signal in samples.

31. The system of claim 22 wherein the processor is part of the receiver and the aiding information is from a server.

32. The system of claim 22 wherein the processor is part of a server, the receiver configured to transmit the signal to the server, and the server configured to transmit the time and/or location to the receiver.

33. The system of claim 22 wherein the aiding information is available to the processor prior to transmission of the signal by the satellite.

34. The system of claim 22 wherein the aiding information is not available to the processor until after transmission of the signal by the satellite.

35. The system of claim 22 wherein the aiding information is from a server with knowledge of transmission of the signal from a transmission provider.

36. The system of claim 22 wherein the aiding information is from another receiver located in a region of better reception from the satellite than the receiver.

37. The system of claim 22 wherein the aiding information is from an earlier time when the receiver was in a better reception environment than a current environment.

38. The system of claim 22 wherein the processor is configured to determine the time and/or location where the approximation assists in a search to match the signal.

39. The system of claim 22 wherein the aiding information comprises ephemeris, a location estimate, and/or a time estimate.

40. The system of claim 22 wherein the aiding information comprises modulation, wherein the processor is configured to approximate the unpredictable characteristic as a signal replica using the modulation, and wherein the processor is configured to determine with a search limited by a number of waveforms created for matching to the signal.

41. The system of claim 22 wherein the processor is part of the receiver, wherein the signal comprises a burst signal from the satellite comprising a low earth orbit satellite, wherein the processor is configured to approximate the at least one unpredictable characteristic as a signal replica, and wherein the processor is configured to determine from the signal using the signal replica.

42. The system of claim 41 wherein the aiding information comprises a number of possible symbols to be used for the burst signal, and wherein the processor is configured to generate the signal replica as part of a search using the possible symbols, the aiding information comprising information to limit the possible symbols to less than the number such that the search is reduced.

43. The system of claim 41 wherein the burst signal is a time division multiple access signal.

44. The system of claim 41 wherein the aiding information comprises signal modulation information.

45. The system of claim 44 wherein the signal modulation information comprises a spread code.

46. The system of claim 41 wherein the aiding information comprises data for the burst signal, position of the satellite, a velocity of the satellite, and clock information for the satellite.

47. The system of claim 41 wherein the processor is configured to determine with a search with different frequency offsets.

48. The system of claim 47 wherein the processor is configured to search with the different frequency offsets applied to the signal replica.

49. The system of claim 47 wherein the processor is configured to search with the different frequency offsets applied to the burst signal.

50. The system of claim 41 wherein the processor is configured to determine the location by correlation of the burst signal with the signal replica.

51. The system of claim 41 wherein the processor is configured to determine the time based on a receiver clock bias determined by correlation of the burst signal with the signal replica.

52. The system of claim 51 wherein the receiver clock bias is determined by the correlation of the burst signal with a matched filtered formed with the signal replica.

53. The system of claim 51 wherein the processor is configured to determine the time as a clock error based on correlation peaks with wildpoint filtering.

54. The system of claim 51 wherein the processor is configured to determine the time as a clock error identified from a sum of correlation curves.

55. The system of claim 41 wherein the processor is configured to set a correlation window based on a computer network time.

56. The system of claim 41 wherein the processor is configured to reconstruct the signal replica as at least 60% of the burst signal.

57. The system of claim 22 wherein the aiding information comprises ephemeris for the satellite, and wherein the processor is configured to determine the time and location assisted by the ephemeris.

58. The system of claim 22 wherein the unpredictable characteristic comprises modulation unpredictable to the receiver based on previous signal transmissions from the satellite wherein the modulation varies burst-to-burst.

59. A method for assisting satellite time and/or location determination, the method comprising:
receiving, by a receiver, a signal broadcast from a low earth orbit satellite, the signal having a high peak power flux density and including a characteristic unpredictable from the signal by the receiver;
approximating the unpredictable characteristic of the signal with aiding information; and
determining the time and/or location of the receiver from the signal with the approximation of the unpredictable characteristic.

60. The method of claim 59 wherein the satellite transmits the signal as a burst transmission in a beam having a beam footprint smaller than footprint of the satellite.

61. The method of claim 59 wherein the unpredictable characteristic is ephemeris or satellite clock error.

62. The method of claim 59 wherein the unpredictable characteristic is a waveform modulation or at least some symbols of an N-PSK signal.

63. The method of claim 59 wherein approximating comprises creating a signal replica and wherein determining comprises finding an alignment of the signal with the signal replica in samples.

64. The method of claim 59 wherein the receiver approximates and determines.

65. The method of claim 59 wherein approximating comprises generating a signal replica from the aiding information comprising satellite position and orbit information, the orbit information and signal modulation sourced from terrestrial communication, wherein the signal broadcast from the satellite has the signal modulation.

66. The method of claim 65 wherein the aiding information is received from a server by the receiver via the terrestrial communication.

67. The method of claim 65 wherein approximating comprises generating a replica signal and wherein determining comprises correlating the replica signal with the signal, a correlation peak or a peak of a sum of correlation curves indicating a clock bias.

68. The method of claim 59 wherein a server approximates and determines and communicates the time and/or location to the receiver.

69. The method of claim 59 further comprising receiving the aiding information prior to the signal broadcast.

70. The method of claim 59 further comprising receiving the aiding information after the signal broadcast.

71. The method of claim 70 further comprising receiving the aiding information from another receiver.

72. The method of claim 59 further comprising receiving the aiding information from a server with knowledge of the broadcast from a broadcast provider.

73. The method of claim 59 further comprising receiving the aiding information as data received by the receiver while the receiver was in a better reception environment than a current reception environment.

74. A system for assisting satellite time and/or location, the system comprising:
a receiver configured to receive a signal from a low earth orbit satellite, the signal including a characteristic unpredictable by the receiver; and
a processor configured to approximate the at least one unpredictable characteristic of the signal based on aiding information and to determine time and/or location of the receiver from the signal and the approximation of at least one unpredictable characteristic of the signal.

75. The system of claim 74 wherein the satellite transmits the signal as a burst transmission in a beam having a beam footprint smaller than footprint of the satellite.

76. The system of claim 74 wherein the unpredictable characteristic is ephemeris or satellite clock error.

77. The system of claim 74 wherein the unpredictable characteristic is a waveform modulation or at least some symbols of an N-PSK signal.

78. The system of claim 74 wherein the processor is configured to approximate by creation of a signal replica and wherein the processor is configured to determine with an alignment of the signal with the signal replica in samples.

79. The system of claim 74 wherein the processor is part of the receiver.

80. The system of claim 74 wherein the processor is configured to approximate by generation of a signal replica from the aiding information comprising satellite orbit information and signal modulation, the satellite orbit information and signal modulation sourced from terrestrial communication, wherein the signal broadcast from the satellite has the signal modulation.

81. The system of claim 80 wherein the aiding information is received from a server by the receiver via the terrestrial communication.

82. The system of claim 80 wherein the processor is configured to generate a signal replica and wherein the processor is configured to determine by correlation of the signal replica with the signal, a correlation peak or a peak of a sum of correlation curves indicating a clock bias.

83. The system of claim 74 wherein the processor is part of a server, the server configured to communicate the time and/or location to the receiver.

84. The system of claim 74 wherein the processor receives the aiding information prior to the signal broadcast.

85. The system of claim 74 wherein the processor receives the aiding information after the signal broadcast.

86. The system of claim 74 wherein the processor is configured to receive the aiding information from a server with knowledge of the broadcast from a broadcast provider.

87. The system of claim 74 wherein the aiding information is from another receiver.

88. The system of claim 74 wherein the aiding information is data received by the receiver while the receiver was in a better reception environment than a current reception environment.

89. A method for assisting satellite time and/or location, the method comprising:
sending a burst request for a signal to be included in a satellite burst transmission;
generating burst data for a receiver configured to receive the satellite burst transmission, wherein the burst data comprises assistance data formatted for determination of the time and/or location from the satellite burst transmission based on the burst data.

90. The method of claim 89 wherein the burst request includes validation data, and wherein sending the burst data comprises sending a subset of the burst request, the subset not including the validation data.

91. The method of claim 89 wherein sending the burst data comprises broadcasting the burst data to the receiver and other receivers.

92. The method of claim 89 wherein sending the burst data further comprises sending, to the receiver, ephemeris data for a satellite performing the satellite burst transmission.
